(19) United States
(12) Patent Application Publication
(10) Pub. No.: US 2018/0280120 A1
(43) Pub. Date: Oct. 4, 2018

(54) POSITIONING SYSTEM

(71) Applicant: Kamil Tech Ltd., Road Town (VG)

(72) Inventor: Uzi BERGER, Hod Hasharon (IL)

(73) Assignee: Kamil Tech Ltd., Road Town (VG)

(21) Appl. No.: 15/995,444

(22) Filed: Jun. 1, 2018

Related U.S. Application Data
(63) Continuation-in-part of application No. 13/961,040, filed on Aug. 7, 2013, now abandoned.
Application No. 13/961,040 is a continuation-in-part of application No. 12/903,607, filed on Oct. 13, 2010, now Pat. No. 8,529,260.

(51) Int. Cl. A61C 8/00; A61C 13/01; A61C 13/107

(52) U.S. Cl. CPC A61C 8/0048; A61C 13/08; A61C 13/0001; A61C 13/01

(57) ABSTRACT

A positioning system is provided, comprising a support beam for attachment to an individual's jaw, and a removable denture comprising a bottom surface formed with a recess configured for receiving therein the support beam, the support beam and the recess being configured to preclude movement therebetween when the support beam is fully received within the recess. The support beam or the recess comprises one or more positioning grooves extending parallel to a path of insertion of the denture, and the other comprises one or more positioning protrusions laterally projecting therefrom and configured to be slidingly received within a corresponding positioning groove to provide at least a partially snug fit. The one or more positioning grooves and the corresponding one or more positioning protrusions are configured on one or more of a labial, lingual, or an face extending between the labial and lingual faces, of the recess and the support beam.

This is a Continuation-In-Part of U.S. application Ser. No. 13/961,040 filed Aug. 7, 2013, which is a Continuation-In-Part of U.S. application Ser. No. 12/903,607 filed Oct. 13, 2010, the contents of which are hereby incorporated by reference in their entirety.

### FIELD OF THE INVENTION

The present disclosed subject matter is generally in the field of positioning systems. More particularly, it is generally in the field of systems for positioning two elements, wherein one is received within the other.

### BACKGROUND OF THE INVENTION

Partial or complete loss of an individual's natural teeth, either or both at the upper and lower jaw, due to age, accident, diseases or other reasons has some serious effects on an individual, both functionally and socially. Lack of teeth poses several serious functional problems such as not being able to chew, speech difficulties, etc. Even more so, a smile with a full set of white teeth is considered something to be desired, i.e., esthetics play an important role in life.

While a denture can be accurately fitted to the alveolar ridge of an individual, it is difficult to retain a denture in position. That is, during normal chewing or talking, the denture has a tendency to ride up out of position on the alveolar ridge, causing speech difficulties, chewing difficulties, and general unsatisfactory use of a denture.

A denture is a removable dental prosthesis which has artificial teeth embedded in a denture base resembling the gum or gingiva. The denture base provides the support for the prosthesis by resting on the gingiva or over a support bar secured to the respective jaw bone by a plurality of dental implants. The underside of the denture base has a depression receptacle that receives at least a portion of the gingiva or support bar, so as to provide a snug, reversible fit of the denture.

In recent years practice has developed of permanently implanting dental implants (at times referred to as dental fixtures or posts) in the bone structure of the mouth. These permanent dental implants are made of hard material acceptable by the body's biological processes (e.g., titanium) and which are locked into position by bone growth. By utilization of the permanently installed implants in the mouth of the individual, the possibility then exists for more readily securing a denture in place either fixedly or removably.

### SUMMARY OF THE INVENTION

According to the present disclosed subject matter there is provided a removable denture system comprising a personalized support beam configured to be fixedly attached to an individual's jaw bone by a plurality of dental implants; a personalized denture conforming with dental parameters of the individual and comprising a bottom surface shaped and sized so as to constitute a super-structure configured for cooperating with the support beam; and a denture locking arrangement for securely locking and unlocking the denture to the support beam. One of the support beam and the super-structure comprises one or more positioning grooves extend parallel to a path of insertion (POI) of the denture, and the other of the super-structure and the support beam, respectively, comprises one or more corresponding laterally projecting positioning projections, each positioning projection configured to cooperate with a corresponding positioning groove, and configured to provide at least partial snug fit together. The support beam and super-structure are configured to eliminate movement therebetween when the super-structure is assembled over the support beam.

The term super-structure, when directed to the above subject matter, denotes a recess within the bottom surfaces of the denture, constituting thereby an integral part thereof.

The term path of insertion (POI), (also known as path of placement) denotes an axis along which the denture is placed onto or removed from the support beam, said line intersecting the occlusal plane of the individual's mouth.

The term occlusal plane denotes the plane on which upper and lower teeth (or dentures) meet.

The location of the positioning grooves and positioning projections can be any location along the periphery of the super-structure and/or the support beam, namely any of the labial and/or lingual surfaces or the end surfaces between which the labial or lingual surfaces extend.

According to another aspect of the disclosed subject matter there is provided a removable denture system comprising: a personalized support beam configured to be fixedly attached to an individual's jaw bone by a plurality of dental implants; a personalized denture conforming with dental parameters of the individual and comprising a bottom surface shaped and sized so as to constitute a super-structure configured for cooperating with the support beam; and a denture locking arrangement for securely locking and unlocking the denture to the support beam. One of the support beam and the super-structure comprises one or more positioning grooves extending parallel to a path of insertion (POI) of the denture, and the other of the super-structure and the support beam, respectively, comprises one or more corresponding laterally projecting positioning projections, each positioning projection configured to cooperate with a corresponding positioning groove and configured for at least partial snug fit therein when the super-structure is assembled over the support beam, contributing thereby to rigidity and grip of the super-structure over the support beam.

A denture according to the present disclosed subject matter can be configured with any one or more of the following designs and features:
the one or more positioning grooves and/or the one or more positioning projections can be configured with a cross-section tapering in the direction of the path of insertion, and/or in a labial or lingual direction (i.e., the positioning projections converge in the direction of the POI, whilst the positioning grooves diverge in that sense;
easy and correct positioning of the super-structure over the support beam is facilitated by providing a directive funnel-like arrangement by either a widening of one or more of the positioning grooves at their top ends and/or narrowing of the positioning projections at their bottom end;
the one or more positioning grooves and the corresponding one or more positioning projections are configured on either of a labial face, a lingual face or end faces of the super-structure and the support beam, or any combination thereof;
at least the one or more positioning grooves may extend the entire height of the respective support beam or super-structure;
at least one of the positioning grooves may extend only partially along the height of its respective support beam or recess, with its corresponding protrusion extending a correspondingly partial amount along the height of its support beam or recess;
each of the personalized denture and support beam can be made of any rigid, metallic or non-metallic material such as, for example, metals-gold, titanium, chrome-cobalt, zirconium, zirconium-oxide, porcelain, ceramics, plastic/acrylic/polymeric materials, composite materials, and combinations thereof;
when the material of which the personalized denture is formed is a structural material, there may be a need to apply thereto a finishing layer mimicking the shape, size, color and texture of the natural teeth;
the one or more positioning grooves and the one or more positioning projections may be configured for sliding engagement, e.g., in the form of dove-tail management;
the one or more positioning grooves and the one or more positioning projections can be configured to have a variety of shapes having different cross-sections, e.g., rounded, polygonal, etc.;
the one or more positioning projections can extend along the entire height of the corresponding positioning grooves, or along a restricted portion thereof, and can also be configured in the shape of protuberances, pins and the like;
the one or more positioning grooves and the one or more positioning projections may be configured to have a staggered arrangement over the labial face, the lingual face or the end faces;
the one or more positioning grooves and the one or more positioning projections may be configured in registered arrangement over the labial face, the lingual face and the end faces;
the positioning projections can be configured such that the bottom base is wider than the top base, both in a plane extending along a posterior-anterior direction, and at a plane substantially parallel to the support beam;
one of the lower surface of the denture and an upper surface of the support beam may be configured with recesses and the other of the lower surface of the denture and an upper surface of the support beam may be configured with corresponding protuberances in register with said recesses;
the recesses and the corresponding protuberances can extend in a radial or other aspect (orientation);
a top surface of the support beam, and respectively a lower surface of the denture can be substantially flat or can be fitted with a ridge. The top surface of the support beam, and respectively a lower surface of the denture can be uniform or may alter along the length thereof;
the lower surface of the denture can bear flush against the top surface of the support beam along at least a portion of its entire length;
the lingual and labial walls of the support beam, and respectively those of the super-structure, may be substantially parallel to one another or inclined with respect to one another (and with respect to the path of insertion), said inclination being in the range of between about 0° to 30°;
at least some of the locations of the projections/grooves may extend in register with locations of the implants.

It is however important that the wall surfaces (lingual, labial, end and bottom) of the super-structure follow and correspond with the shape of the respective walls (lingual, labial, end and top) of the support beam (i.e., the denture) and all said walls and surface are substantially in full contact with each other in a tight and snug fit, thereby ensuring motionless fitting of the denture over the support beam while facilitating its easy mounting and removal, per demand only.

The provision of laterally projecting positioning projections over the support beam plays a further role in reinforcing the support beam and in increasing the resistance of the support beam to bending moments, shear moments and torsion moments acting on the support beam. In particular, provision of such positioning projections adjacent to the location of bores formed in the support beam for securing to the dental implants significantly increases resistance of the support beam to bending moments, shear moments and torsion moments acting on the support beam, rendering it competent for bearing significant forces applied during chewing, biting and tearing actions performed by the individual wearing a denture. That is even more so when considering proximal locations of dental implant bores.

According to an aspect of the presently disclosed subject matter, there is provided a positioning system comprising:
a personalized support beam configured to be fixedly attached to an individual's jaw;

a personalized removable denture conforming with dental parameters of the individual and comprising a bottom surface formed with a recess configured for receiving therein the support beam, the support beam and the recess being configured to preclude movement therebetween when the support beam is fully received within the recess;

wherein one of the support beam and the recess comprises one or more positioning grooves formed therein and extending parallel to a path of insertion of the denture, and the other of the recess and the support beam comprises one or more positioning protrusions laterally projecting therefrom and configured to be slidingly received within a corresponding positioning groove to provide at least a partially snug fit, the positioning grooves and/or positioning protrusions formed so as to taper along the path of insertion, and

wherein the one or more positioning grooves and the corresponding one or more positioning protrusions are configured on one or more a labial face, a lingual face, and an end face extending between the labial and lingual faces, of the recess and the support beam.

The one or more positioning protrusions and the one or more positioning grooves may comprise a funnel-like configuration providing easy and correct positioning of the recess over the support beam.

One or more of the positioning grooves may extend the entire height of the support beam or the recess.

One or more of the positioning grooves may extend partially along the height of its respective support beam or recess, with its corresponding positioning protrusion extending no more than a correspondingly partial amount along the height of its respective support beam or recess.

The positioning protrusions may be configured on the support beam, the recess following the shape of the support beam, maintaining a thickness substantially conforming with a corresponding decrease of thickness of the personalized denture.

The one or more positioning protrusions may extend a height ranging between a full height to a portion of the height of the corresponding positioning grooves.

The bottom surface of the denture or an upper surface of the support beam may comprise recesses and/or depressions, and the other of the bottom surface of the denture and an upper surface of the support beam being configured with corresponding protuberances and/or additional positioning protrusions in register with the recesses or depressions.

A top surface of the support beam, and respectively the bottom surface of the denture, may each comprise a flat portion.

A top surface of the support beam, and respectively the bottom surface of the denture, may comprise one or more ridges.

Walls of the support beam, and respective walls of the bottom surface of the denture, may be substantially parallel to one another.

Wall surfaces of the bottom surface of the denture forming the recess may cooperate with the respective walls of the support beam and corresponding surfaces of the walls to provide the snug fit together, to eliminate any tolerances between the recess and support beam, to thereby ensure motionless fitting of the denture over the support beam and however facilitating for its easy mounting and removal.

The positioning system may further comprise a locking arrangement for securely locking and unlocking the denture to the support beam.

The locking arrangement may be configured such that it does not bear any loads.

The support beam may be configured to be fixedly attached to the individual's jaw bone by a plurality of dental implants.

### BRIEF DESCRIPTION OF THE DRAWINGS

In order to understand the disclosed subject matter and to see how it may be carried out in practice, examples will now be described, by way of non-limiting examples only, with reference to the accompanying drawings, in which:

FIGS. 1A to 1C illustrate an exploded isometric view of a denture system in accordance with an example of the present disclosed subject matter, showing mounting and removal of the denture and a bottom view of the denture and a support bar;

FIG. 2 is a lingual view of the denture of FIGS. 1A and 1B;

FIG. 3 is an exploded posterior view, partially sectioned, of the denture system in accordance with the present disclosed subject matter;

FIG. 4 is a section along line IV-IV in FIG. 2;

FIGS. 5A and 5B are a labial perspective view and top view, respectively, of a support beam in accordance with an example of the present disclosed subject matter;

FIGS. 6A and 6B are perspective labial bottom view and bottom view, respectively, of a denture in accordance with the present disclosed subject matter; configured for use in conjunction with the support beam of FIGS. 5A and 5B;

FIGS. 7A and 7B are exploded perspective views of a denture system in accordance with a different example of the present disclosed subject matter, the denture illustrated at its upright position;

FIGS. 8A and 8B are a labial perspective view and a top view, respectively, of a support beam in accordance with yet an example of the present disclosed subject matter;

FIGS. 9A and 9B are a labial perspective bottom view and a bottom view, respectively, of a denture in accordance with the present disclosed subject matter, configured for use in conjunction with the support beam of FIGS. 8A and 8B;

FIGS. 10A and 10B are schematic illustrations, at an enlarged scale, of a labial portion of the support beam illustrated in FIG. 8a and a respective portion of the super-structure illustrated in FIG. 9A;

FIGS. 10C and 10D illustrate a longitudinal section through a denture system showing consecutive steps of mounting/removal of the denture;

FIGS. 11A and 11B are a labial perspective view and a top view, respectively, of a support beam in accordance with another example of the present disclosed subject matter;

FIGS. 12A and 12B are a perspective labial bottom view and a bottom view, respectively, of a denture configured for use in conjunction with the support beam of FIGS. 11A and 11B;

FIGS. 13A and 13B are a labial perspective view and a top view, respectively, of a support beam in accordance with a different example of the present disclosed subject matter;

FIGS. 14A and 14B are a perspective labial bottom view and a bottom view, respectively, of a denture used in conjunction with the support beam of FIGS. 13A and 13B;

FIGS. 15A and 15B are a labial perspective view and a top view, respectively, of a support beam in accordance with a modified example of the present disclosed subject matter;

FIGS. 16A and 16B are a perspective labial bottom view and a bottom view, respectively, of a denture used in conjunction with the support beam of FIGS. 15A and 15B;

FIGS. 17A and 17B are a labial perspective view and a top view, respectively, of a support beam configured in accordance with a different example of the present disclosed subject matter;

FIGS. 18A and 18B are a perspective labial bottom view and a bottom view, respectively, of a denture configured for use in conjunction with the support beam of FIGS. 17A and 17B;

FIGS. 19A and 19B illustrate a sectioned portion along line V-V in FIG. 2, illustrating a retractable pin-type locking mechanism at its respective unlocked and locked position;

FIG. 20A is an exploded perspective sectioned view of a locking mechanism for use in conjunction with a denture system of the disclosed subject matter;

FIG. 20B is a longitudinal section along line B-B in FIG. 20A;

FIG. 20C is a longitudinal section along line C-C in FIG. 20A;

FIG. 21A illustrates a schematic top superposition of the denture system fitted with a locking mechanism of the disclosed subject matter at a locked position;

FIG. 21B illustrates the locking arrangement of FIG. 21A at its unlocked position;

FIG. 21C is a longitudinal section illustrating the denture system fitted with a locking mechanism of the disclosed example at the mounted, arrested position;

FIG. 21D illustrates a denture system wherein the denture is removed from the support beam;

FIG. 22A is a schematic top representation of a modification of the locking arrangement illustrated in FIGS. 21A and 21B at a locked position;

FIG. 22B is a section taken along line D-D in FIG. 22A;

FIG. 23A is a perspective portion of a locking arrangement in accordance with a different example of the present disclosed subject matter;

FIG. 23B is an enlargement of the encircled portion illustrated in FIG. 23A;

FIG. 23C is a schematic longitudinal section along the locking mechanism of FIG. 23A, illustrating the denture lockingly secured over the support beam;

FIG. 23D is a top view of the support beam taken in direction of arrow F in FIG. 23B;

FIG. 23E is a schematic top view of the denture of FIG. 23A exemplifying the locking arrangement;

FIG. 24A is a superimposed schematic illustration illustrating the locking arrangement at its open position;

FIG. 24B illustrates the locking arrangement at its locked position;

FIGS. 25A to 25C illustrate an exploded isometric view of a denture system according to another example of the present disclosed subject matter, showing mounting and removal of the denture and a bottom view of the denture and a support bar;

FIG. 26 is a lingual view of the denture of FIGS. 25A and 25B;

FIG. 27 is an exploded posterior view, partially sectioned, of the denture system in accordance with the present disclosed subject matter;

FIG. 28 is a section along line VI-VI in FIG. 26; and

FIGS. 29 and 30 are isometric views of support beams according to another example of the present disclosed subject matter.

### DETAILED DESCRIPTION OF EMBODIMENTS

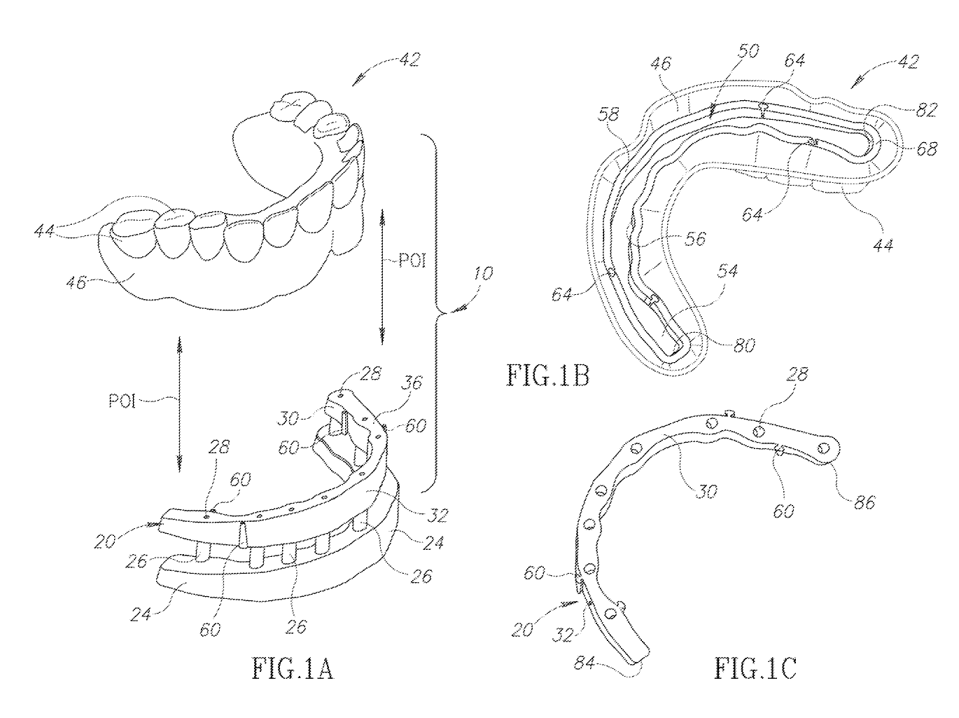

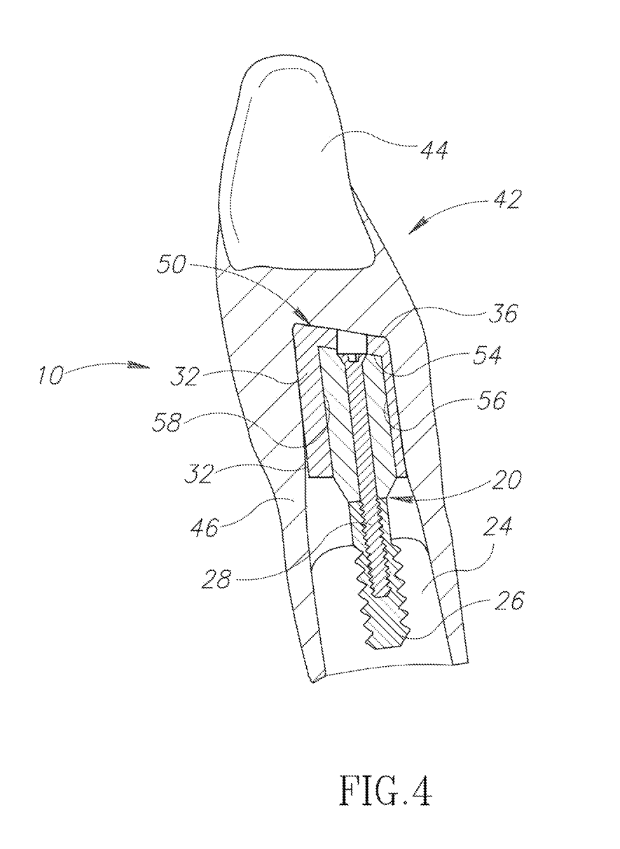

Attention is first directed to FIGS. 1 to 4 of the drawings illustrating a denture system generally designated 10, in accordance with the present disclosed subject matter. The denture system 10 comprises a support beam 20 fixedly secured to a jaw bone 24 (i.e., to the individual's alveolar ridge above the mucous membrane) of an individual, by a plurality of dental implants 26 received within the jaw bone 24 and wherein the support beam 20 is secured to the dental implants 26 by appropriate screws 28.

The support beam 20 follows the general arched shape of the jaw 24 and is configured with a lingual (inside) face 30, a labial (external) face 32 and a top surface 36.

The top surface 36 of the support beam 20 can be substantially flat and smooth over its entire length, as shown in the drawings. It should be appreciated, however, that the top surface can be at least partially rough and have small projections and/or recesses therealong.

The denture 42 is configured for detachably mounting over the support beam 20 as will be discussed hereinafter and is personalized so as to conform with dental parameters of the individual namely comprises a plurality of teeth 44 resembling the natural teeth of the individual as far as shape, size and color, and a gum-mimicking portion 46 configured to extend below the support beam when mounted thereon and to cover at least a portion of the mucous membrane (the natural gum portion of the individual).

Fixedly integrated within a bottom surface of the personalized denture 42 there is a super-structure 50 having a cross-section conforming with that of the support beam 20 and adapted for at least partially snugly mounting thereover, for example at substantially zero tolerance.

The super-structure 50 is provided with an upper wall 54 being substantially flat and smooth configured for flush positioning over the top surface 36 of the support beam 20. The super-structure 50 is further provided with a lingual surface 56 and a labial surface 58, each extending between two opposite end surfaces 80 and 82, for flush engagement with the corresponding lingual surface 30, labial surface 32, and end surfaces 84 and 86 (FIG. 1C) of the support beam 20.

It should be appreciated that the super-structure is designed so as to cooperate with the top surface of the support beam. Thus, in the case that the support beam is at least partially rough, as indicated above, the upper wall of the super-structure will be shaped accordingly.

Manufacture of the support beam 20 and the personalized denture 42 is disclosed for example in U.S. Pat. No. 7,806,691.

It is appreciated that the personalized denture 42 is configured for application to and removal from the support beam 20 along a path of insertion (POI) namely the axis along which the personalized denture 42 is placed onto, or removed from the support beam 20, intersecting the occlusal plane of the individual's mouth.

As can further be seen, in particular in FIGS. 1A and 1B, the support beam 20 is configured with a plurality of laterally projecting positioning projections 60 (four in the present case, two at each of the lingual surface 30 and labial surface 32) said positioning projections 60 extending parallel to the path of insertion and parallel to one another, whilst the super-structure 50 is configured with a corresponding number of positioning grooves 64 extending therein to cooperate with the positioning projections 60 namely configured for snugly sliding thereover, for example at substantially zero tolerance.

It should be appreciated that the super-structure 50 may be configured with any number of positioning grooves 64, which can be formed in any of the surfaces, namely the lingual surface 56, the labial surface 58 and any of the end surfaces 80 and 82.

It is noted, in the particular example, that the positioning projections 60 extend along the entire height of the support beam 20 and are configured with a rounded shape so as to minimize irritation upon removal of the personalized denture 42. On the other hand, the positioning grooves 64 extend from the lowermost surface 68 of the super-structure up to the top surface 54 and as mentioned hereinabove, are configured for snug sliding over the positioning projections 60.

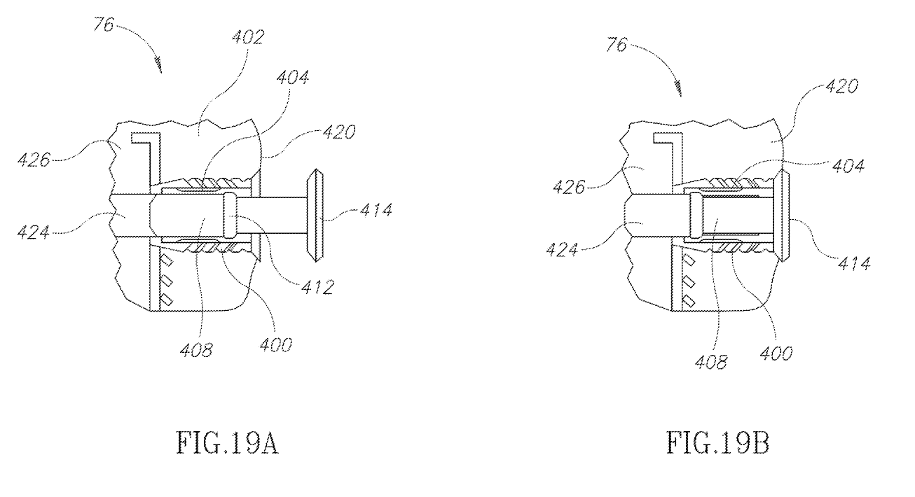

The denture system 10 is further configured with a locking mechanism 76 which in the present example is a pin-type locking arrangement disclosed in further detail in FIGS. 19A and 19B.

It is appreciated that the above locking mechanism 76, at the locked position, does not bear any loads but rather, the super-structure 50 of the personalized denture is mounted over the support beam 20 with substantially zero tolerances therebetween.

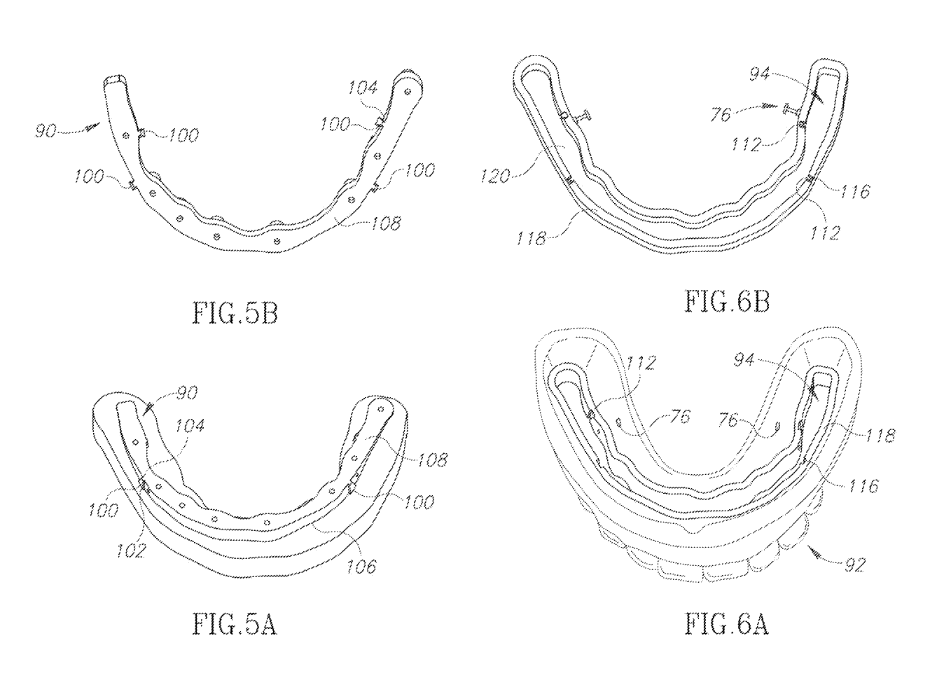

Further attention is now directed to FIGS. 5 and 6 of the drawings wherein the general features of the support beam generally designated 90 and the personalized denture generally designated 92 with the integrated super-structure generally designated 94 substantially follow the features as discussed hereinabove in connection with FIGS. 1 to 4.

However, in the particular illustrated example of FIGS. 5A and 5B the positioning projections 100 are trapezoidal, i.e., having a wide bottom base 102 narrowing upwards towards a top narrow base 104 wherein, in the particular example, the bottom base 102 extends flush along a bottom edge 106 of the support beam 90 and the top base 104 extends flush with a top, flat surface 108 thereof. In correspondence therewith, the super-structure 94 is configured with four corresponding positioning grooves 112 each having a cross-section corresponding with that of the positioning projections 100 of the support beam 90 i.e., the positioning grooves 112 have a tapering cross-section with a wide opening 116 extending at a lowermost surface 118 of the super-structure 94 and with a narrow top portion extending at the inner surface 120 of the super-structure 94, configured for flush mounting over the top surface 108 of the support beam 90.

It is appreciated that the trapezoidal configuration of the positioning projections 100 and the corresponding positioning grooves 112 facilitate easy mounting of the personalized denture 92 over the support beam 90 whereby the wide opening 116 of the positioning grooves 112 is placed over the narrow, top base 104 of the positioning projections 100. This thus provides a funnel-like arrangement, easing placing of the personalized denture over the support beam 90; however this does not diminish the firm support provided to the personalized denture 92 over the support beam 90 when fully received thereon.

Further, the denture system collectively illustrated in FIGS. 5 and 6 is configured with a pin-like locking mechanism 76 of the type disclosed hereinafter with further detail in FIGS. 19A and 19B.

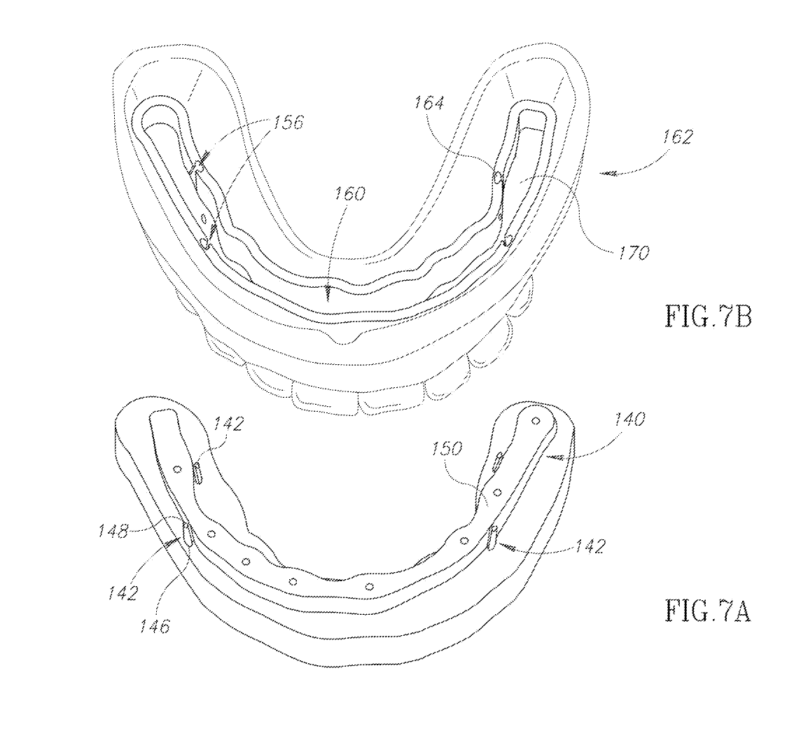

Turning now to FIGS. 7A and 7B there is illustrated a modification of the example illustrated in FIGS. 5 and 6. According to this example, the support beam generally designated 140 is configured with positioning projections 142 laterally projecting from the lingual surface and labial surface, respectively, and extending parallel to the path of insertion as discussed hereinabove. However, the positioning projections 142 have a trapezoidal cross-section (similar to the disclosure of FIGS. 5A and 5B) namely having a wide bottom base 146 and a narrow top base 148, said top base extending flush with the top surface 150 of the support beam 140, and further when each of the positioning projections 142 has a dove-tail configuration, configured for sliding engagement within the corresponding positioning grooves 156 formed in the super-structure 160 of the personalized denture 162. Accordingly, the positioning grooves 156 have a corresponding configuration so as to snugly slide over the positioning projections 142, i.e., the positioning grooves 156 are configured with a trapezoidal cross-section extending between a bottom, wide opening at 164 and narrowing upwards towards the upper surface 170 of the super-structure 160.

It is appreciated that the dove-tail type positioning configuration of grooves and projections further reduces movement between the super-structure and the integrated personalized denture whilst mounted over the support beam, thus eliminating any movement.

It is further appreciated that the provision of the laterally projecting positioning projections 142 significantly increases resistance of the support beam 140 to bending moments, shear moments and torsion moments acting on the support beam, thus increasing its stability and endurance. On the other hand, it is appreciated that at those locations where the super-structure 160 is provided with positioning grooves, the overall thickness of the walls of the super-structure are not thinner but rather maintain a substantially uniform thickness.

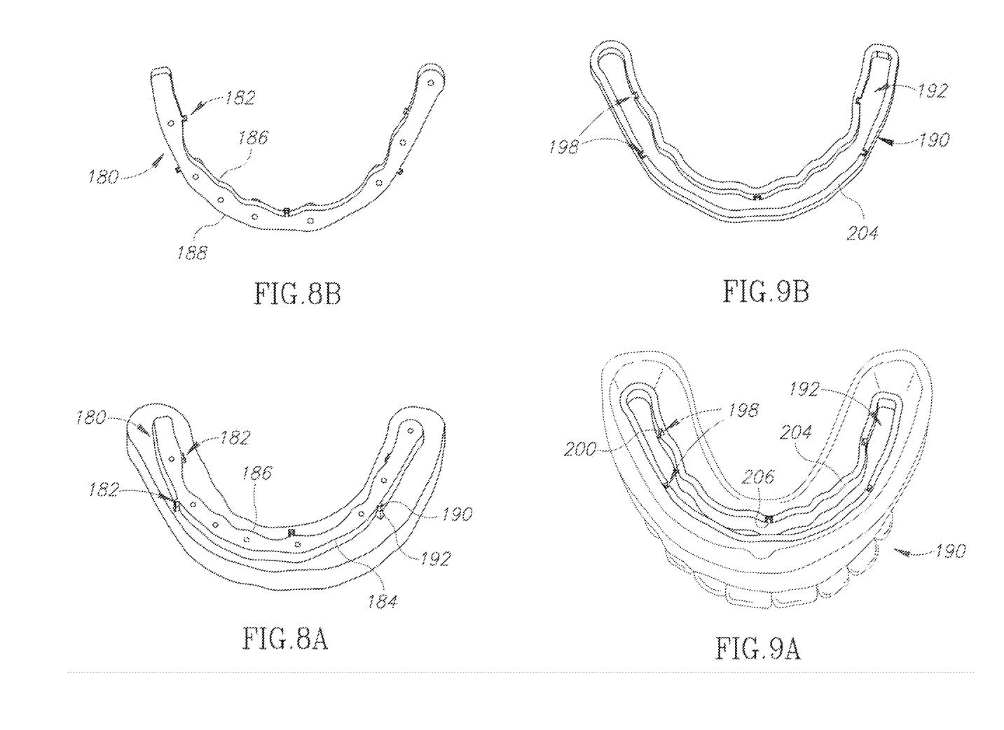

With reference to FIGS. 8 and 9 there is now illustrated yet another example of a denture system in accordance with the present disclosed subject matter resembling, to a large extent the configuration of FIGS. 5 and 6, however wherein the support beam 180 is configured with a plurality of positioning projections generally designated 182 wherein in this example two lateral positioning projections extend from the front, labial surface 184 and three positioning projections 182 extend from the inside, lingual surface 186. It is noted that the positioning projections 182 are configured with a substantially straight portion 187 extending parallel to the path of insertion (POI) and having a substantially rectangular cross-section though with chamfered/rounded edges to cause minimal irritation to the individual, and further there is a lower widening portion 188.

Correspondingly, the personalized denture 190 is configured with an integrated super-structure 192 configured with corresponding positioning grooves 198 wherein a bottom opening thereof designated 200, substantially flush with a lowermost surface 204 of the super-structure 192 is substantially wider and narrows upwardly into a rectangular form at 206 with a shape matching that of the corresponding positioning projections 182 and configured for snugly mounting thereon. The widening opening at 200 facilitates easy mounting and positioning of the personalized denture 190 over the support beam 180 wherein upon placing the personalized denture 190 and positioning it over the support beam 180, the personalized denture 190 becomes fixedly positioned to the support beam 180, without any tolerances therebetween as discussed hereinabove.

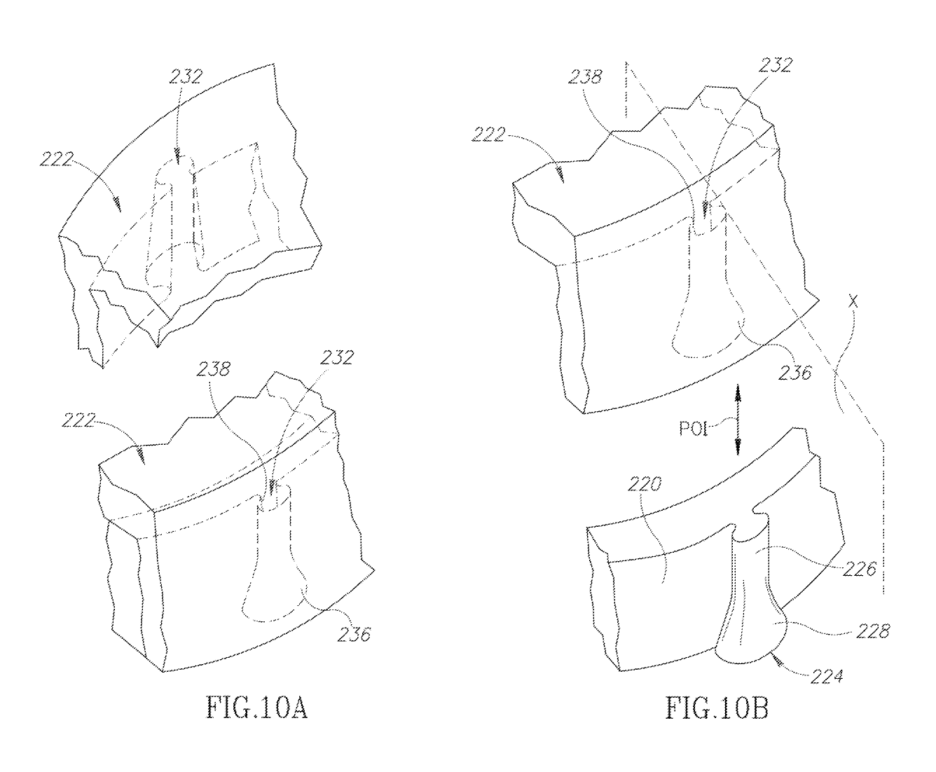

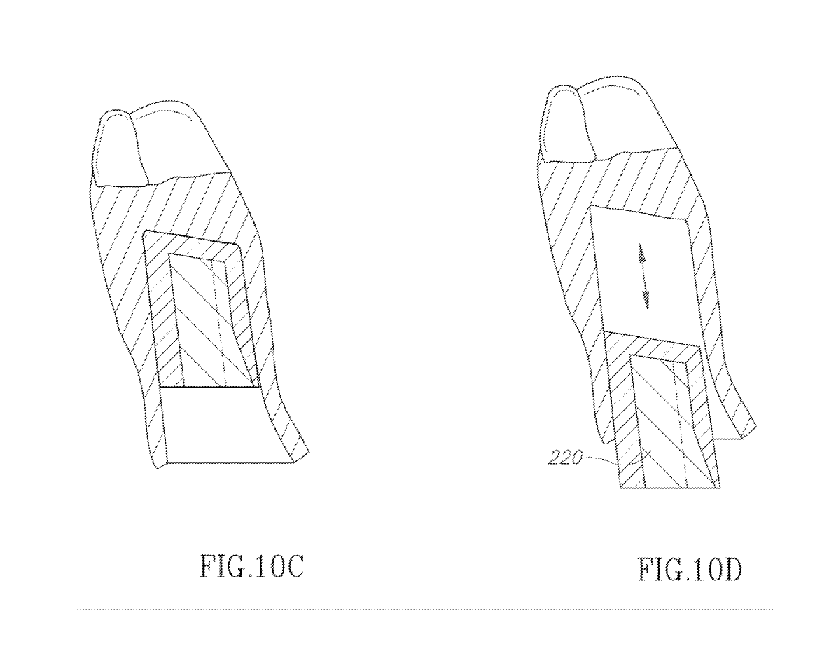

Likewise, the positioning projections 182 may be configured such that the bottom base is wider than the top base, both in a plane extending along a posterior-anterior direction, and at a plane substantially parallel to the support beam 180 (FIGS. 10A-10D).

It should be appreciated, in connection with any of the examples discussed herein, that the number of positioning projections and respective positioning grooves may change as well as their location and their shape and size. Accordingly, one denture system may comprise several different types of positioning projections and corresponding positioning grooves, as long as the general concept of snug fitting is present, with substantially zero tolerance therebetween.

FIGS. 10A and 10B illustrate, at an enlarged scale, only a portion of a support beam 220 and a portion of a corresponding super-structure 222 wherein the positioning projection 224 configured on the support beam 220 is a combined configuration having a dove-tail arrangement, with a top portion 226 extending substantially parallel to the POI and a bottom portion 228 tapering in both a lateral and a planar direction (see also FIGS. 10C and 10D) and wherein the corresponding positioning groove 232 of the super-structure 222 has a widening opening at its bottom edge 236 narrowing upwards and terminating at a top end 238, corresponding in cross-section with the positioning projection 224.

FIGS. 10C and 10D are cross-sections taken along section plane X in FIGS. 10A and 10B illustrating consecutive sets of mounting a personalized denture with the integrated super-structure over a corresponding support-beam, configured with a positioning groove and positioning projection, respectively.

Whilst in the examples illustrated herein so far the positioning projections were configured on the support beam and respectively the positioning grooves were configured in the super-structure, in the following examples of FIGS. 11 to 14, the positioning projections are configured on the super-structure and respectively the positioning grooves are configured in the support beam.

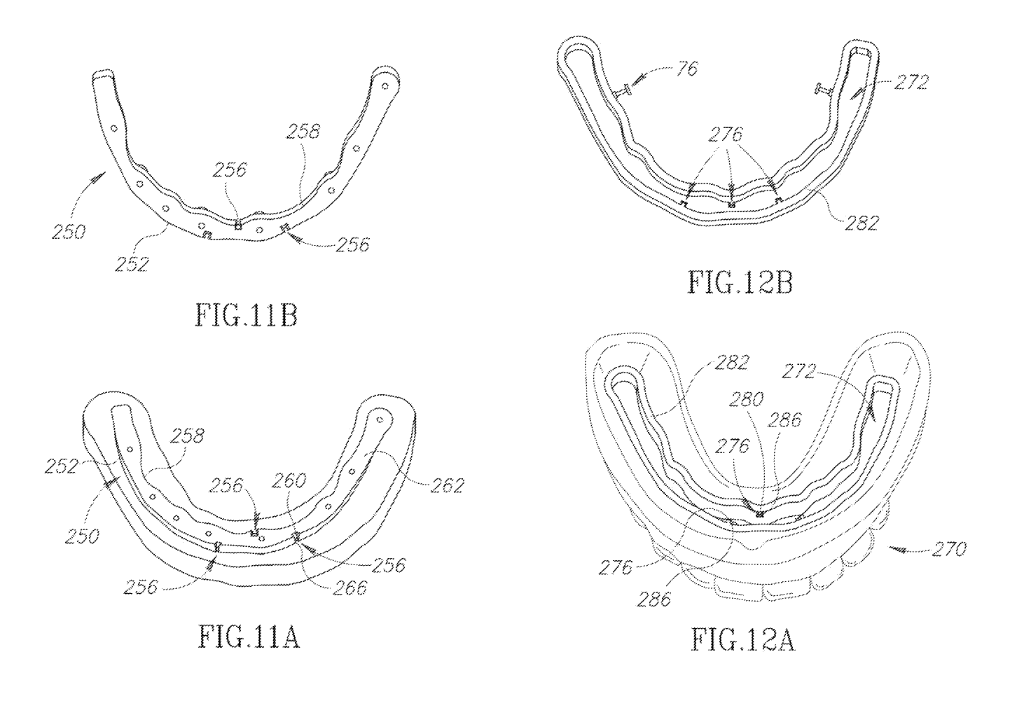

Turning first to FIGS. 11 and 12 it is noted that the support beam 250 is configured at its labial face 252 with two positioning grooves generally designated 256 and one positioning groove 256 configured on the lingual face 258.

The positioning grooves 256 extend parallel to the path of insertion (POI) of the denture and, in the particular example, the positioning grooves 256 have a top, widened opening 260, extending from the top, substantially flat and smooth surface 262 of the support beam 250 and tapering downwards towards a substantially rectangle section 266, in a funnel like configuration.

As noted in FIGS. 12A and 12B, the personalized denture 270 is configured with a integrated super-structure 272 which in turn is configured with three positioning projections 276 configured for snug and tight receipt within the corresponding positioning grooves 256 configured on the support beam 250. Thus, each of the positioning projections 276 is configured with a substantially rectangular, lower portion 280 extending from a bottom surface 282 of the super-structure 272, said positioning projections 276 widening at their top portion 286 in a fashion corresponding with the shape of the respective positioning grooves of the support beam 250.

Similar to the previous example, in this case too, the denture system is configured with a locking mechanism which in the present example is a pin-type lock mechanism 76, of the type disclosed hereinafter with particular reference to FIGS. 19A and 19B.

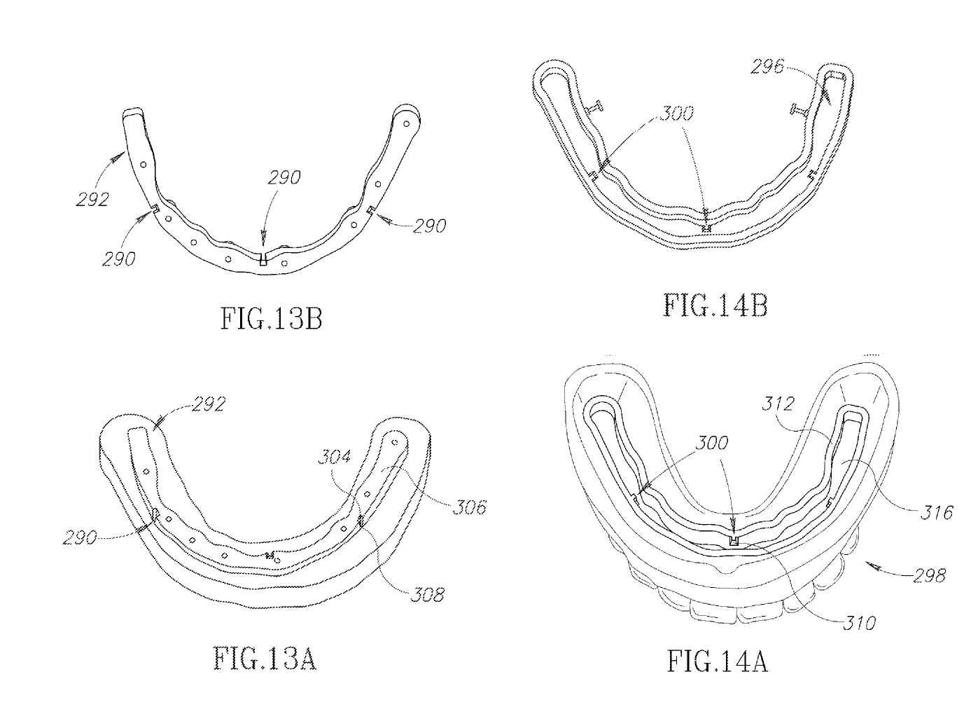

FIGS. 13 and 14 illustrate a modification of the example illustrated in connection with FIGS. 11 and 12 wherein the positioning grooves 290 are configured on the support-beam 292 and respectively, the super-structure 296 of the personalized denture 298 is configured with corresponding positioning projections 300 projecting laterally inwards, namely into the confined space of the super-structure 296.

The positioning grooves 290 and the respective positioning projections 300 have a tapering cross-section, namely wherein the positioning grooves 290 have a wide top opening 304 extending flush with a top surface 306 of the support beam 292 and terminating at a bottom, narrow base 308 thereof. Respectively, the positioning projections 300 of the super-structure 296 extend from a narrow, bottom base 310 extending flush from a bottom edge 312 of the super-structure 296 and widening upwards towards the top surface 316 of the super-structure 296.

In this example too, the configuration is such that mounting of the personalized denture 298 is facilitated and is directed by the funnel-type arrangement of the positioning grooves, however, upon positioning of the personalized denture 298 to its final location over the support beam 292, the personalized denture 298 becomes rigidly supported and with substantially zero tolerance i.e., with substantially no motion between the personalized denture 298 and the support-beam 292.

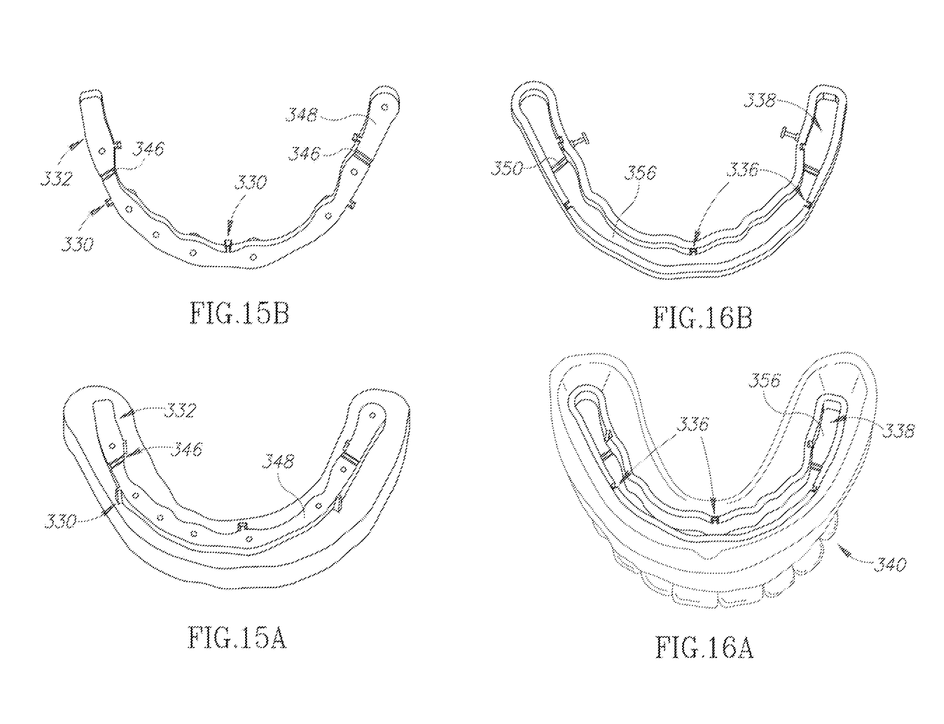

Turning now to FIGS. 15 to 18 there are illustrated different examples of denture systems in accordance with the present disclosed subject matter. FIGS. 15 and 16 resemble in a way the denture system disclosed in connection with FIGS. 5 and 6 respectively, at least as far as the provision and shape of the positioning projections 330 formed on the support beam 332 and the respective laterally projecting positioning grooves 336 configured on the super-structure 338 of the personalized denture 340. However, in addition to said positioning grooves 336 and corresponding positioning projections 330, the denture system of FIGS. 15 and 16 further comprises a set (two in the present example) of upwardly projecting positioning projections 346 extending from the top smooth surface 348 of the support beam 332 with corresponding depressions 350 formed in the top surface 356 of the super-structure 338, in correspondence with said positioning projections 346, thereby facilitating true-positioning between the respective support beam 332 and the super-structure 338 with the integrated personalized denture 340.

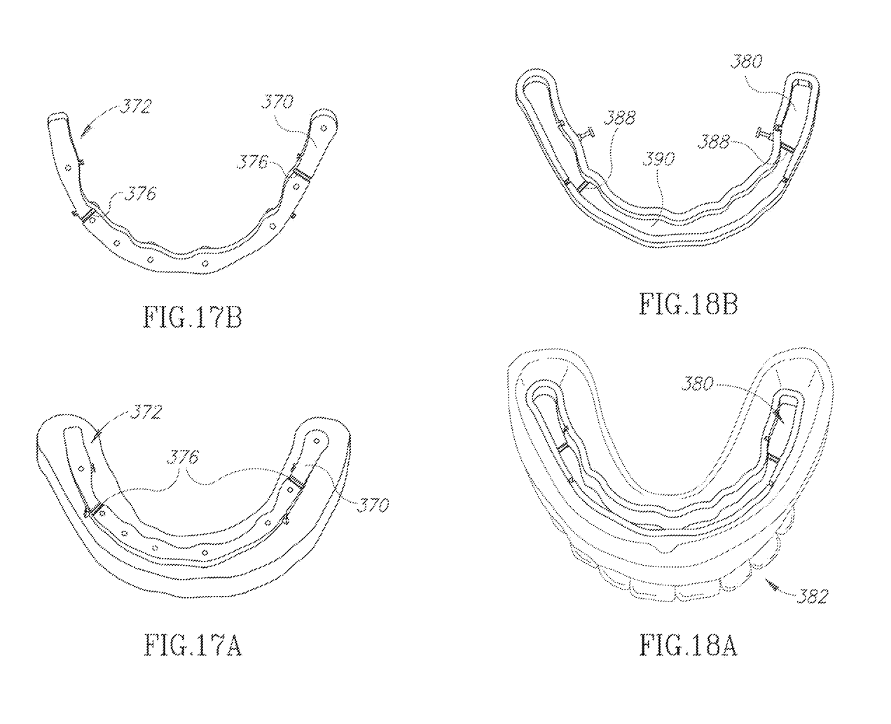

The example of FIGS. 17 and 18 illustrates an arrangement resembling that of FIGS. 15 and 16, however with the laterally positioning projections and corresponding positioning grooves resembling those of FIGS. 8 and 9, and further, in the top, substantially flat surface 370 of the support beam 372 there are configured two positioning grooves 376 whilst the super-structure 380 of the personalized denture 382 is configured with corresponding positioning projections 388 extending from the top, substantially flat surface 390 of the super-structure 380, configured for snug fitting and receipt within the respective positioning grooves 376 formed on the support-beam 372. It is noted that the respective positioning grooves and positioning projections illustrated in connection with FIGS. 15 and 16, and 17 and 18, respectively, extend such that their respective walls are either parallel to the path of insertion (POI) or constitute an acute angle therewith. Further, the depth of the positioning groove and the corresponding height of the respective positioning projection is such as to ensure surface mating (surface to surface contact) thereof.

As mentioned hereinabove, the denture systems disclosed hereinbefore are fitted with a locking mechanism. According to one example, the locking mechanism is a pin-type lock 76, discussed with further detail in FIG. 19A (open, unlocked position) and FIG. 19B (closed, locked position).

The lock 76 comprises a housing 400 rigidly embedded within the personalized denture 402, wherein said housing comprises a sleeve 404 comprising an elastomeric or ceramic material. The lock 76 comprises a locking pin 408 formed with an annular displacement limiting ring 412 configured for snapping arrestment by the sleeve 404, said pin being displaceable between a locked position (FIG. 19B) and an unlocked position (FIG. 19A). The locking pin 408 is fitted with a substantially flat head portion 414 which at the locked position extends in close proximity with the lingual surface 420 of the personalized denture, thus causing minimal irritation to the individual, while facilitating retraction thereof e.g., by the individual's fingernail (for that purpose a small interstice is typically configured between the inner surface of the head 414 and the lingual surface 420). The arrangement is such that the locking pin 408 is fitted for snugly fitting within corresponding bore 424 configured in the respective support-beam 426, in a fashion wherein substantially no load is borne by the pin while in the locked position.

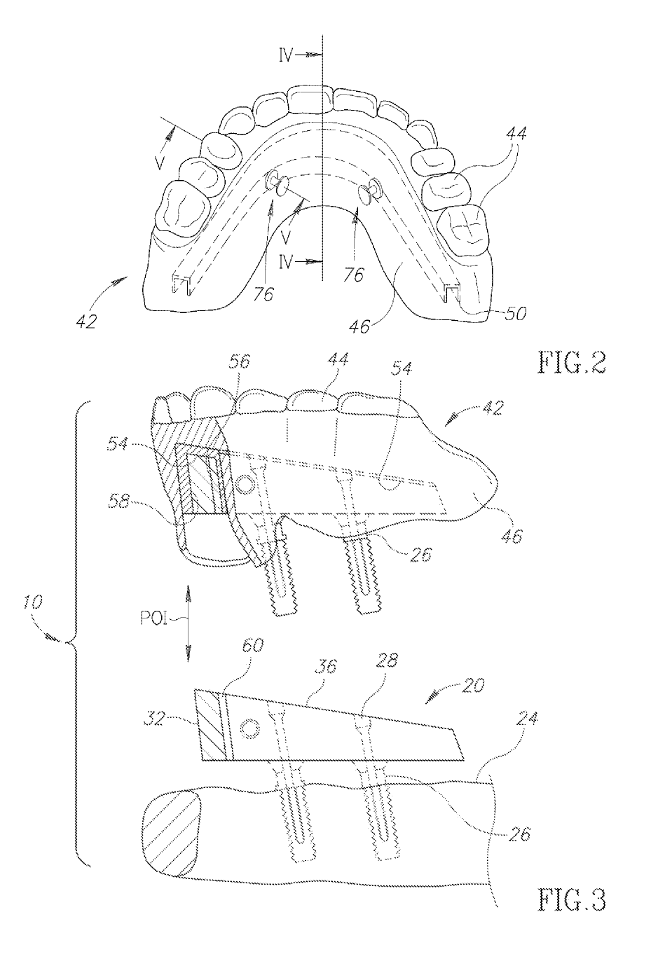

In some cases, the personalized denture is fitted with a throughgoing bore also at its labial face, with a corresponding throughgoing locking bore formed in the support beam, wherein in case of difficulty in extracting of the locking pin 408 a sharp article may be inserted through the opening (e.g., a paper staple and the like) to facilitate pushing the locking pin 408 in the lingual direction into its extracted position (FIGS. 2, 19A). However, such an opening on the labial surface of the personalized denture is miniature and hardly visible to the eye.

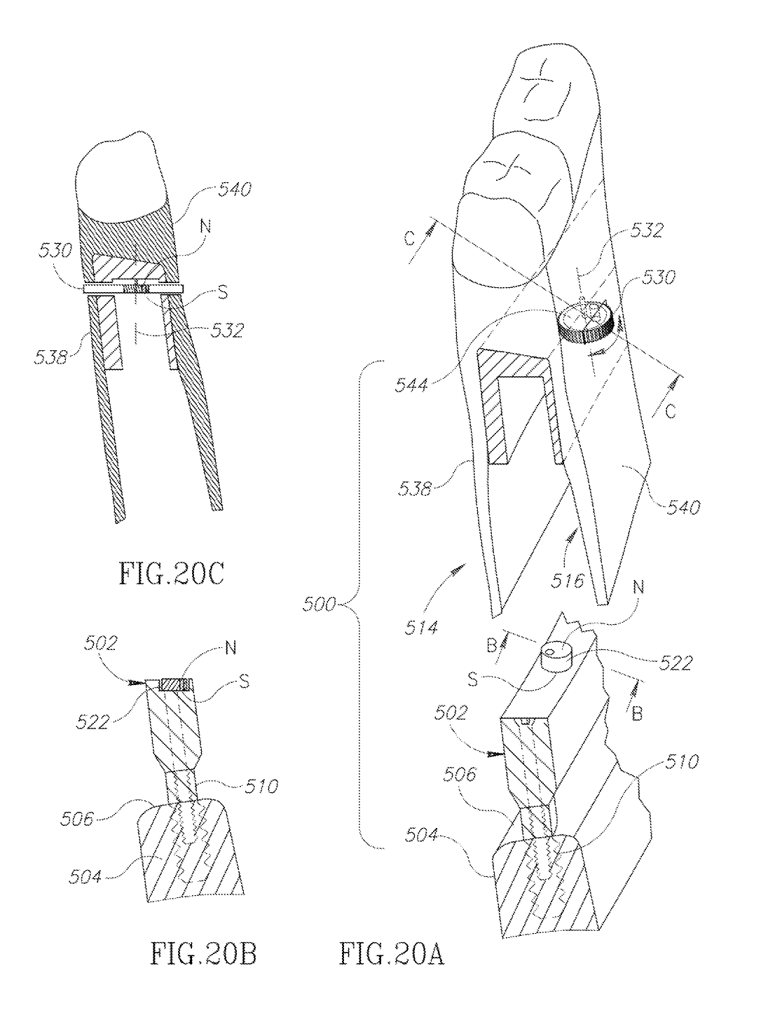

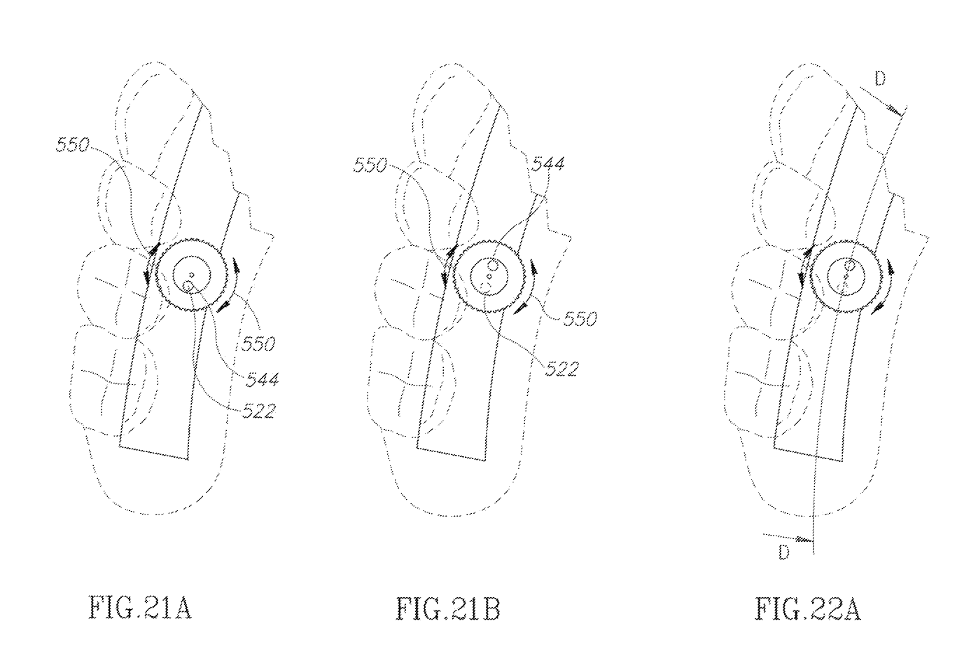

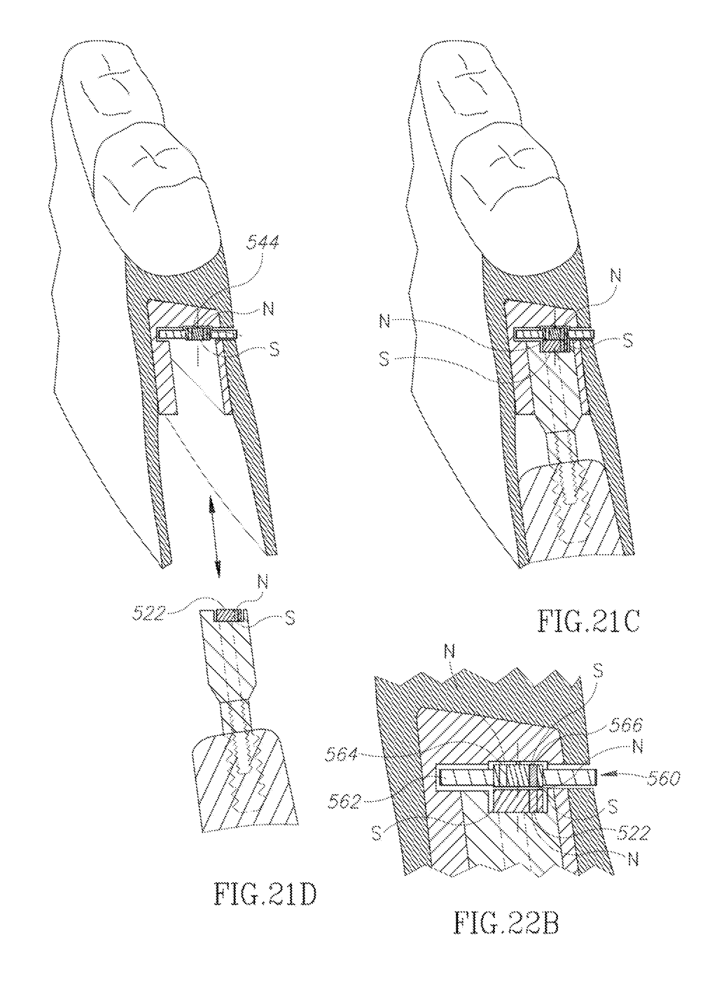

Turning now to FIGS. 20 and 21 there is illustrated a locking mechanism in accordance with a different configuration of the present disclosed subject matter.

The locking mechanism, generally designated 500 comprises a support beam 502 of the type fixedly attached to an individual's alveolar ridge 504 above the mucous membrane 506 by a plurality of dental implants 510.

The denture system 500 further comprises a personalized denture 514 conforming with dental parameters of the individual and having fixedly integrated within a bottom surface thereof a super-structure generally designated 516 having a cross-section conforming with that of the support beam 502 and configured for snug and tolerance-free engagement over the support-beam 502. The locking mechanism comprises at least one first magnet 522 fixedly received within the support beam 502 and oriented such that its North pole faces upwards and its South pole faces downwards. A disk-like manipulator 530 is received within the personalized denture 514 and is rotatably secured about an axis of rotation 532 substantially parallel to an axis of said first magnet 522. The manipulator 530 laterally projects, partially from at least one or both of the lingual or labial face 538 and 540, respectively and is fixedly fitted with at least one second magnet 544 oriented in an opposite sense from the first magnet 522, namely with its south (S) pole facing downwards and its north (N) pole facing upwards.

The disk-like manipulator 530 is displaceable between a locked position (FIG. 21A) where the second magnet 544 extends substantially coaxially with and above the first magnet 522, giving rise to an attraction force extending therebetween and wherein as a result the personalized denture 514 is attracted to the support beam 502 and will thus not spontaneously detach therefrom. The manipulator 530 is further displaceable into an unlocked position (FIG. 21B), upon rotation of the disk-like manipulator 530 as illustrated by arrowed lines 550, whereby the second magnet 544 is displaced from its locked position above the first magnet 522, such that the attraction force therebetween ceases or substantially diminishes. In this manner, the personalized denture 514 may be easily removed from the support beam 502.

It is appreciated that the number of locking mechanisms of the aforementioned type fitted in a denture system may vary depending on the space provided in the denture system and accordingly, the attracting force may be controlled by providing magnets with different force and for that purpose, small though powerful magnets (e.g., neodymium magnets) may be used.

Furthermore, it is noted that one of the first magnet 522 and second magnet 544 may be a piece of ferrous metal configured for attraction to a magnetic member provided at either the support beam 502 or the denture 514.

In FIGS. 22A and 22B there is illustrated a modification of the example disclosed in connection with FIGS. 20 and 21, wherein the support beam is configured with a single magnet as illustrated in the previous example whilst the personalized denture 560 is configured with a disk-like manipulating member 562 fitted with two magnets 564 and 566, the former oriented as in the previous example namely with its south (S) pole facing downwards and its north (N) pole facing upwards, and the latter magnet 566 extending with its north (N) pole facing downwards and its south (S) pole facing upwards.

The arrangement is such that at a first orientation of the manipulator, attraction forces extend between the first magnet 522 of the support beam and the second magnet 566 of the personalized denture 560, whilst unlocking the locking mechanism is facilitated by rotating the manipulator 562 to a position where the magnet 564 extends above the first magnet 522, giving rise to rejection forces therebetween, facilitating easy extracting and removal of the denture.

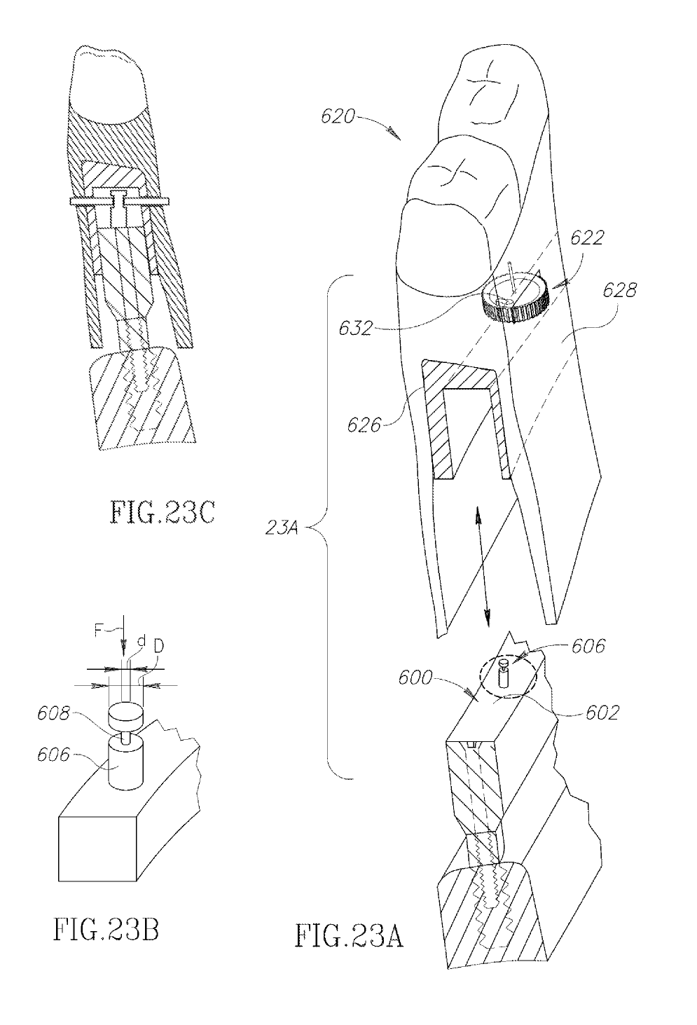

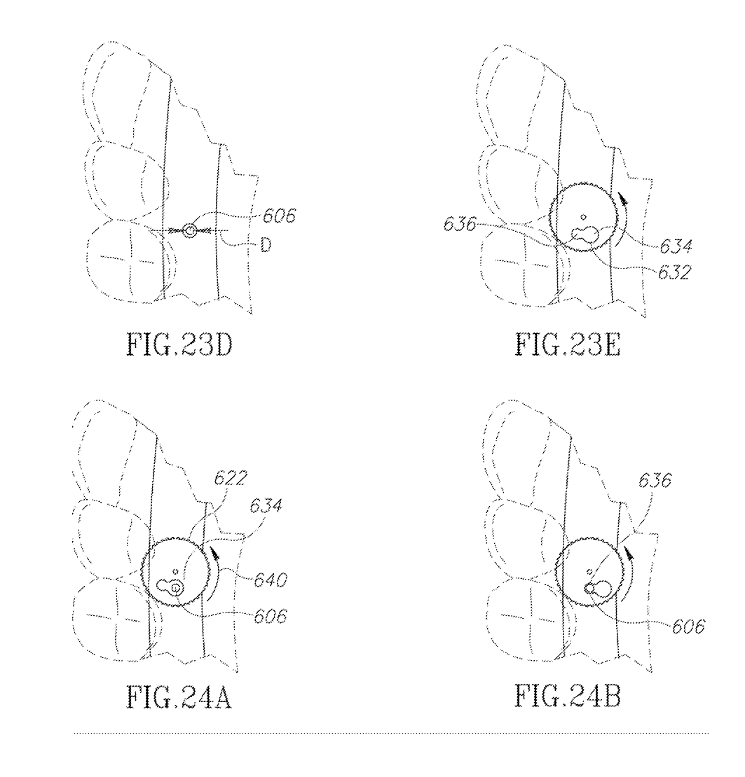

Turning now to FIGS. 23A-23E there is illustrated a locking mechanism according to yet a different configuration wherein the support beam 600 is of the type disclosed hereinbefore and comprises at its top, substantially flat surface 602 one or more upwardly projecting locking studs 606 configured with a locking recess 608.

The personalized denture 620 is configured with a disk-like manipulator 622 projecting from either or both the lingual surface 626 or labial surface 628 and rotatable about an axis substantially parallel to a longitudinal axis of the locking stud 606, said locking manipulator is configured with a locking aperture 632 having a wide portion 634 and a narrow portion 636 (FIG. 23E) wherein the wide portion 634 is at least as wide as the diameter D of the locking stud 606 and the narrow portion 636 is as narrow as the recessed portion d (FIG. 23B) of the locking stud 606.

At the unlocked position the personalized denture 620 is positioned over the support beam 600 allowing the stud 606 to project into the wide portion 634 of the locking aperture 632 (FIG. 24A) thereby obtaining proper positioning and seating of the personalized denture 620 over the support beam 600. Locking takes place by rotation of the manipulating member 622 in direction of arrow 640 (FIG. 24A) whereby the narrow portion 636 of the locking aperture 632 lockingly arrests the locking recess 608 of the locking stud 606, thus preventing unintentional displacement of the denture from the support beam and eliminating any forces.

It is appreciated that according to any of the above disclosed locking mechanisms, at the locked position, the locking mechanism does not bear any loads but rather, the super-structure of the personalized denture snugly bears over the support beam with substantially zero tolerances therebetween.

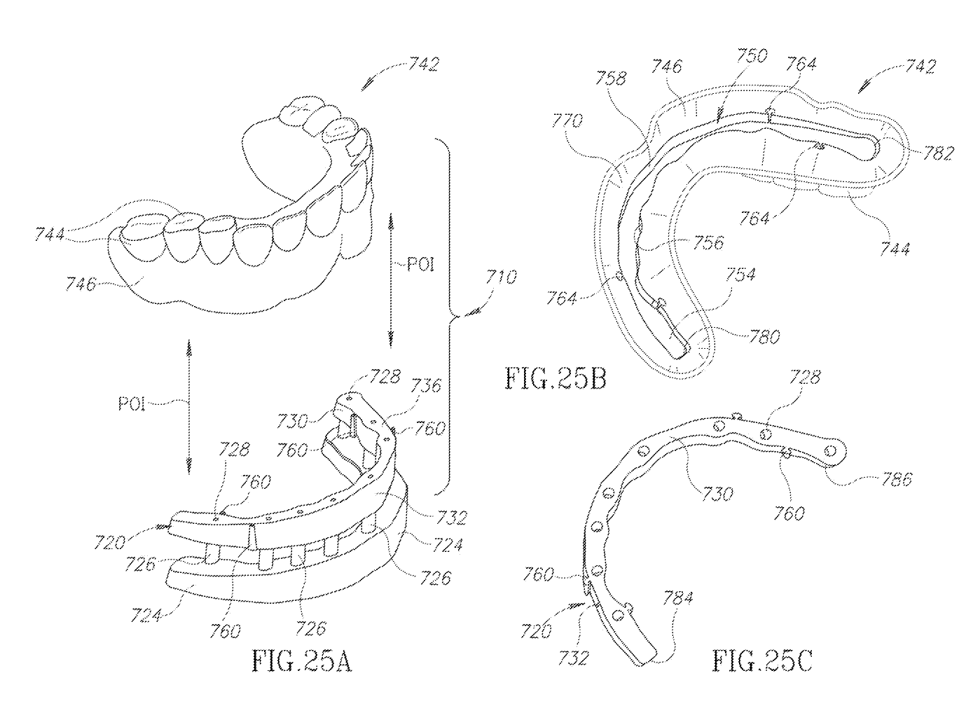

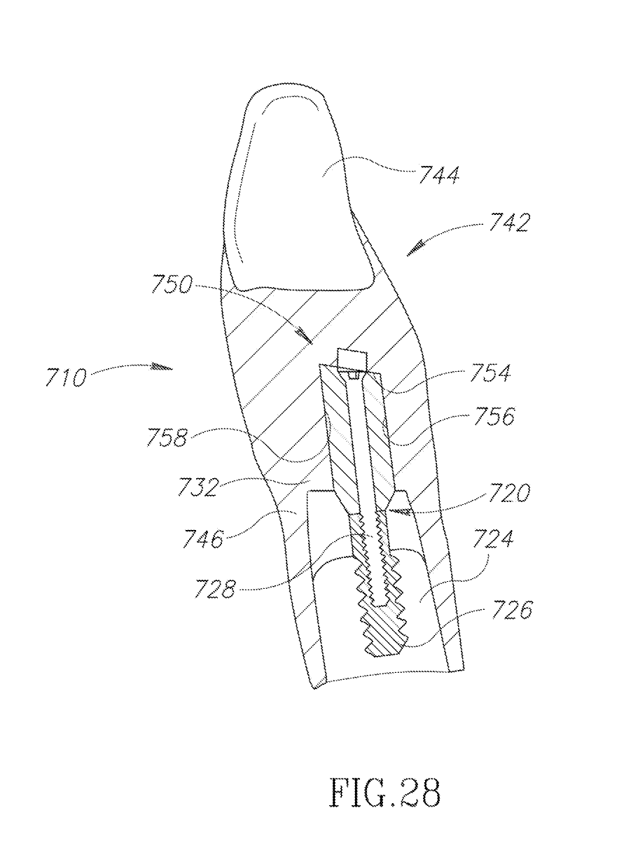

Reference is now being made to FIGS. 25A to 28, showing another example of a denture system 710, in accordance with presently disclosed subject matter.

The denture system 710 comprises a support beam 720 fixedly secured to a jaw bone 724 (i.e., to the individual's alveolar ridge above the mucous membrane) of an individual, by a plurality of dental implants 726 received within the jaw bone 724 and wherein the support beam 720 is secured to said dental implants 726 by appropriate screws 728.

The support beam 720 is similar to the support beam as described for example with reference to FIGS. 1 to 4.

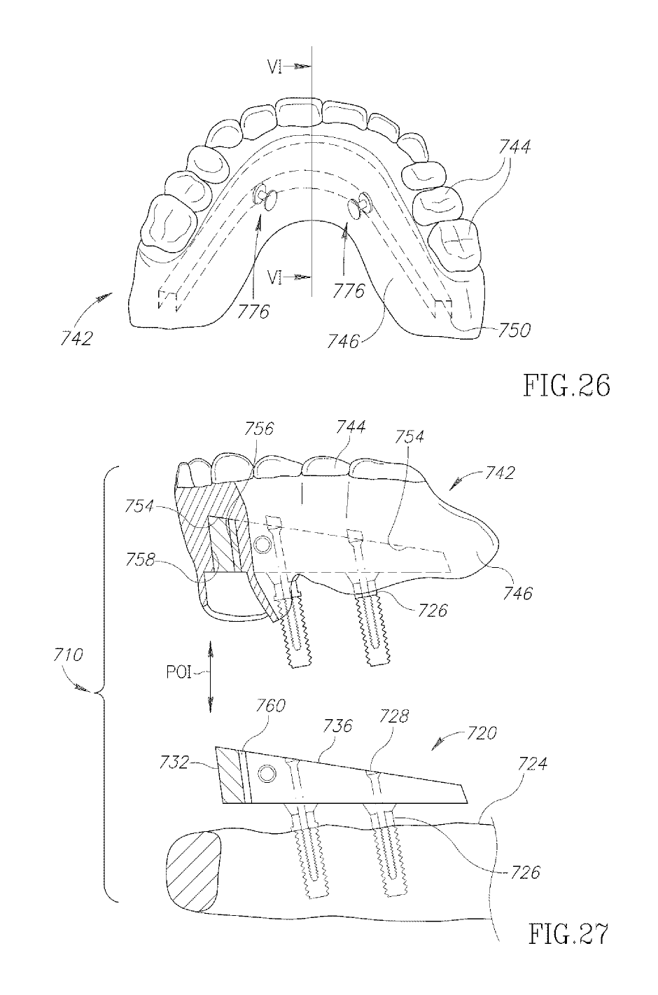

The denture 742 is configured for detachably mounting over the support beam 720 (FIGS. 26 to 28), as detailed below, and is personalized so as to conform with dental parameters of the individual namely comprises a plurality of teeth 744 resembling the natural teeth of the individual as far as shape, size and color, and a gum-mimicking portion 746 configured to extend below the support beam when mounted thereon and to cover at least a portion of the mucous membrane (the natural gum portion of the individual).

The denture 742 comprises a bottom surface 770 formed with a recess 750 along a portion thereof, defined by an upper wall 754, a lingual surface 756, labial surface 758 (shown also in FIG. 26), and two opposite end surfaces 780 and 782 extending between the lingual surface 756 and the labial surface 758.

The recess 750 has a cross-section conforming with that of the support beam 720 and adapted for cooperating with the support beam 720. In particular, the recess 750 is sized and shaped so as to at least partially snugly mount over the support beam 720 (FIGS. 26 to 28), by positioning substantially flat and smooth surfaces of the recess 750 over corresponding substantially flat and smooth surfaces 736, 730, 732, 784 and 785 (FIGS. 25A and 25C) of the support beam 720.

The recess 750 can be embedded with an additional layer made of a material different from that of the denture.

The denture 742 can be manufactured by machining or precision molding, or a combination of the two.

As shown in FIG. 25B, the recess 750 is configured with a plurality of positioning grooves 764 extending substantially perpendicular to the lingual surface 756 the labial surface 758, or the end surfaces 780 and 782, and parallel to the path of insertion (POI), as explained with reference to FIGS. 1 to 4.

It should be appreciated that the recess 750 may be configured with any number positioning grooves, which can be formed in any of the surfaces defining the recess, as indicated above.

The positioning grooves 764 of the recess 750 are configured to cooperate with corresponding positioning projections 760 (FIGS. 25A and 25C) of the support beam 720, and fit thereover, as explained with reference to FIGS. 1 to 4.

It should be appreciated that the denture is designed so that the recess thereof cooperates with the top surface of the support beam. Thus, in the case that the support beam is at least partially rough, the denture will be shaped accordingly.

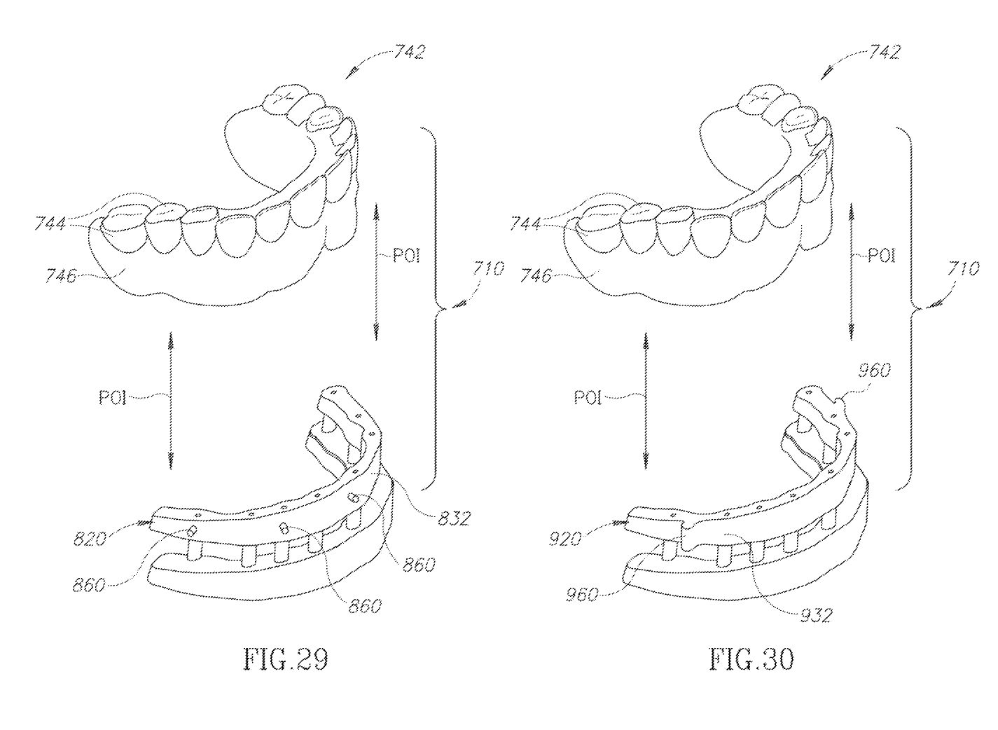

Referring now to FIGS. 29 and 30, there are shown other examples of support beams 820 and 920, having positioning projections 860 and 960, respectively.

The positioning projections 860 extend only along a portion of the wall 832 of the support beam 820.

The positioning projections 960 are of an irregular shape, and are asymmetrical with respect to the wall 932 of the support beam 920.

It should be appreciated that the corresponding positioning grooves of the super-structures and the dentures described above are shaped to cooperated with any shape of their corresponding projections.

While there have been shown several examples of the disclosed subject matter, it is to be understood that many changes may be made therein without departing from the spirit of the invention, mutatis mutandis. For example, the denture system according to the disclosed subject matter may be designed with a support beam configured with one or more positioning projections and one or more positioning grooves, and the super-structure be configured corresponding with one or more positioning grooved and one or more positioning projections, respectively.

1. A positioning system comprising:
a personalized support beam configured to be fixedly attached to an individual's jaw;
a personalized removable denture conforming with dental parameters of the individual and comprising a bottom surface formed with a recess configured for receiving therein the support beam, the support beam and the recess being configured to preclude movement therebetween when the support beam is fully received within the recess;
wherein one of the support beam and the recess comprises one or more positioning grooves formed therein and extending parallel to a path of insertion of the denture, and the other of the recess and the support beam comprises one or more positioning protrusions laterally projecting therefrom and configured to be slidingly received within a corresponding positioning groove to provide at least a partially snug fit, said positioning grooves and/or positioning protrusions formed so as to taper along the path of insertion, and
wherein the one or more positioning grooves and the corresponding one or more positioning protrusions are configured on one or more of a labial face, a lingual face, or an end face extending between the labial and lingual faces, of the recess and the support beam.

2. The positioning system according to claim 1, wherein the one or more positioning protrusions and the one or more positioning grooves comprise a funnel-like configuration providing easy and correct positioning of the recess over the support beam.

3. The positioning system according to claim 1, wherein one or more positioning grooves extend the entire height of its respective support beam or the recess.

4. The positioning system according to claim 1, wherein one or more of the positioning grooves extends partially along the height of its respective support beam or recess, and its corresponding positioning protrusion extends no more than a correspondingly partial amount along the height of its respective support beam or recess.

5. The positioning system according to claim 1, wherein the positioning protrusions are configured on the support beam, the recess follows the shape of the support beam, maintaining a thickness substantially conforming with a corresponding decrease of thickness of the personalized denture.

6. The positioning system according to claim 1, wherein the one or more positioning protrusions extend a height ranging between a full height to a portion of the height of the corresponding positioning grooves.

7. The positioning system according to claim 1, wherein the bottom surface of the denture or an upper surface of the support beam comprises recesses and/or depressions, and the other of the bottom surface of the denture and an upper surface of the support beam is configured with corresponding protuberances and/or additional positioning protrusions in register with said recesses or depressions.

8. The positioning system according to claim 1, wherein a top surface of the support beam, and respectively the bottom surface of the denture, each comprises a flat portion.

9. The positioning system according to claim 1, wherein a top surface of the support beam, and respectively the bottom surface of the denture, comprises one or more ridges.

10. The positioning system according to claim 1, wherein walls of the support beam, and respective walls of the bottom surface of the denture, are substantially parallel to one another.

11. The positioning system according to claim 1, wherein wall surfaces of the bottom surface of the denture forming the recess cooperate with the respective walls of the support beam and corresponding surfaces of the walls to provide the snug fit together, to eliminate any tolerances between the recess and support beam, to thereby ensure motionless fitting of the denture over the support beam and however facilitating for its easy mounting and removal.

12. The positioning system according to claim 1, further comprising a locking arrangement for securely locking and unlocking the denture to the support beam.

13. The positioning system according to claim 12, wherein the locking arrangement does not bear any loads.

14. The positioning system according to claim 1, wherein said support beam is configured to be fixedly attached to the individual's jaw bone by a plurality of dental implants.
